(19) United States
(12) Patent Application Publication
(10) Pub. No.: US 2025/0102779 A1
(43) Pub. Date: Mar. 27, 2025

(54) ZOOM LENS AND IMAGE PICKUP APPARATUS

(71) Applicant: CANON KABUSHIKI KAISHA, Tokyo (JP)

(72) Inventor: Kazuhiro TERADA, Tokyo (JP)

(21) Appl. No.: 18/829,339

(22) Filed: Sep. 10, 2024

(30) Foreign Application Priority Data
Sep. 21, 2023 (JP) 2023-156558

(51) Int. Cl. G02B 13/00; G02B 13/14; G02B 15/14

(52) U.S. Cl. CPC G02B 13/009; G02B 13/0055; G02B 13/146; G02B 15/145519

(57) ABSTRACT

A zoom lens includes in order from an object side to an image side, one or more negative lens units each having a negative refractive power, and a positive lens unit having a positive refractive power, in which the one or more negative lens units include a BN lens unit including at least one BN negative lens, in which a refractive index of the BN negative lens, an Abbe number of the BN negative lens, and a partial dispersion ratio of the BN negative lens are appropriately set.

### BACKGROUND

### Technical Field

The present disclosure relates to a zoom lens and an image pickup apparatus.

### Description of the Related Art

In a surveillance camera, a digital still camera, a video camera, and a broadcasting camera, a zoom lens having a wide angle of view capable of photographing in a wide range is required.

Image pickup apparatuses such as monitoring cameras use visible light for daytime imaging and near-infrared light for nighttime imaging. For example, in surveillance cameras, in nighttime imaging, near-infrared light having a wavelength of 800 nm to 1000 nm is used to facilitate imaging under low illuminance. Therefore, a zoom lens in which various aberrations are satisfactorily corrected in a wide wavelength range from a visible region (wavelength of about 400 nm to 700 nm) to a near-infrared region is required to be used for a surveillance camera or the like.

Further, from the viewpoint of handling, improvement in installation, and the like, miniaturization of the entire camera is desired, and further miniaturization of the zoom lens is required.

Conventionally, as a zoom lens having a wide angle of view and a small size, a negative lead type zoom lens has been known (Japanese Patent Application Laid-Open No. 2019-120822 and Japanese Patent Application Laid-Open No. 2008-65051). In addition, a zoom lens of a negative lead type in which various aberrations are satisfactorily corrected over a wide wavelength range from the visible region to the near-infrared region is known (Japanese Patent Application Laid-Open No. 2019-61005).

### SUMMARY

According to embodiments of the present invention, a zoom lens includes in order from an object side to an image side, one or more negative lens units each having a negative refractive power, and a positive lens unit having a positive refractive power,
wherein the one or more negative lens units include a BN lens unit including at least one BN negative lens,
wherein the following inequalities are satisfied,

$$1.6 < nd\_BNn < 2 \text{.00}$$

$$25. < vd\_BNn < 55.$$

$$0.4958 < θCt\_BNn - 0.00417 \times vd\_BNn < 0.5508$$

where nd_BNn represents a refractive index of the BN negative lens, vd_BNn represents an Abbe number of the BN negative lens, and θCt_BNn represents a partial dispersion ratio of the BN negative lens.

Further features of the present disclosure will become apparent from the following description of exemplary embodiments with reference to the attached drawings.

### BRIEF DESCRIPTION OF THE DRAWINGS

FIG. 1 is a cross-sectional view of a zoom lens according to Embodiment 1 at a wide-angle end when focused on an object at infinity.

FIG. 2A is an aberration diagram of the zoom lens according to Embodiment 1 at the wide-angle end.

FIG. 2B is an aberration diagram of the zoom lens according to Embodiment 1 at an intermediate focal length.

FIG. 2C is an aberration diagram of the zoom lens according to Embodiment 1 at a telephoto end.

FIG. 3 is a cross-sectional view of a zoom lens according to Embodiment 2 at a wide-angle end when focused on the object at infinity.

FIG. 4A is an aberration diagram of the zoom lens according to Embodiment 2 at the wide-angle end.

FIG. 4B is an aberration diagram of the zoom lens according to Embodiment 2 at an intermediate focal length.

FIG. 4C is an aberration diagram of the zoom lens according to Embodiment 2 at a telephoto end.

FIG. 5 is a cross-sectional view of a zoom lens according to Embodiment 3 at a wide-angle end when focused on the object at infinity.

FIG. 6A is an aberration diagram of the zoom lens according to Embodiment 3 at the wide-angle end.

FIG. 6B is an aberration diagram of the zoom lens according to Embodiment 3 at an intermediate focal length.

FIG. 6C is an aberration diagram of the zoom lens according to Embodiment 3 at a telephoto end.

FIG. 7 is a cross-sectional view of a zoom lens according to Embodiment 4 at a wide-angle end when focused on the object at infinity.

FIG. 8A is an aberration diagram of the zoom lens according to Embodiment 4 at the wide-angle end.

FIG. 8B is an aberration diagram of the zoom lens according to Embodiment 4 at an intermediate focal length.

FIG. 8C is an aberration diagram of the zoom lens according to Embodiment 4 at a telephoto end.

FIG. 9 is a cross-sectional view of a zoom lens according to Embodiment 5 at a wide-angle end when focused on the object at infinity.

FIG. 10A is an aberration diagram of the zoom lens according to Embodiment 5 at the wide-angle end.

FIG. 10B is an aberration diagram of the zoom lens according to Embodiment 5 at an intermediate focal length.

FIG. 10C is an aberration diagram of the zoom lens according to Embodiment 5 at a telephoto end.

FIG. 11 is a cross-sectional view of a zoom lens according to Embodiment 6 at a wide-angle end when focused on the object at infinity.

FIG. 12A is an aberration diagram of the zoom lens according to Embodiment 6 at the wide-angle end.

FIG. 12B is an aberration diagram of the zoom lens according to Embodiment 6 at an intermediate focal length.

FIG. 12C is an aberration diagram of the zoom lens according to Embodiment 6 at a telephoto end.

FIG. 13 is a cross-sectional view of a zoom lens according to Embodiment 7 at a wide-angle end when focused on the object at infinity.

FIG. 14A is an aberration diagram of the zoom lens according to Embodiment 7 at the wide-angle end.

FIG. 14B is an aberration diagram of the zoom lens according to Embodiment 7 at an intermediate focal length.

FIG. 14C is an aberration diagram of the zoom lens according to Embodiment 7 at a telephoto end.

FIG. 15 is a schematic diagram of an image pickup apparatus including a zoom lens according to any one of embodiments 1 to 7.

FIG. 16 is a schematic diagram of an image pickup apparatus including a zoom lens according to any one of embodiments 1 to 7.

### DESCRIPTION OF THE EMBODIMENTS

Hereinafter, a zoom lens according to the exemplary embodiments will be described.

A zoom lens according to the exemplary embodiments is a negative lead type zoom lens including in order from an object side to an image side, one or more lens units having a negative refractive power and a lens unit having a positive refractive power. The one or more lens units having a negative refractive power include a lens unit BN (BN lens unit) having a negative refractive power.

The lens unit BN includes at least one negative lens BNn (BN negative lens) satisfying the following inequalities (1), (2), and (3),

$$1.6 < nd\_BNn < 2 \text{.00} \qquad ( 1 )$$

$$25. < vd\_BNn < 55. \qquad ( 2 )$$

$$0.4958 < θCt\_BNn - 0.00417 \times vd\_BNn < 0.5508 \qquad ( 3 )$$

where, nd_BNn, vd_BNn, and θCt_BNn respectively indicate the refractive index, Abbe number, and partial dispersion ratio of the negative lens BNn.

Here, the Abbe number vd and the partial dispersion ratio θCt are given as follows,

$$v d = ( n d - n t ) / ( n F - nC )$$

$$θ Ct - ( n C - n t ) / ( n F - n C )$$

where nd, nC, nt and nF represent the refractive indexes at the d-line, the C-line, the t-line, and the F-line of the Fraunhofer line, respectively.

The inequality (1) defines a range of the refractive index of the negative lens BNn. If the upper limit of the inequality (1) is exceeded, there is substantially no choice for the glass material. If the value falls below the lower limit of the inequality (1), the refractive index of the glass material is too small, so that the curvature of lens surface becomes large in order to maintain the refractive power of the negative lens BNn, and various aberrations deteriorate, which is not preferable.

The inequality (2) defines a range of Abbe numbers of the negative lens BNn. Since the lens unit BN has a negative refractive power, it is desirable that the negative lens BNn included in the lens unit BN has low dispersion in order to reduce chromatic aberration. If the upper limit of the inequality (2) is exceeded, since a glass material having a large refractive index in the near-infrared region with respect to the visible region is selected, the chromatic aberration of magnification in the near-infrared region with respect to the visible region deteriorates when the chromatic aberration of magnification in the visible region is corrected, which is not preferable. When the value falls below the lower limit value of the inequality (2), the chromatic aberration of magnification in the visible region deteriorates because the dispersion becomes too high, which is not preferable.

The inequality (3) defines a range of the partial dispersion ratio of the negative lens BNn. If the value exceeds the upper limit value of the inequality (3), the value of the partial dispersion ratio is too large, and thus it is difficult to sufficiently obtain the effect of correcting chromatic aberration of magnification in the near-infrared region, which is not preferable. When the value falls below the lower limit value of the inequality (3), there is substantially no choice of the glass material.

It is preferable to limit the inequalities (1), (2), and (3) as follows.

$$1.65 < nd\_BNn < 1.93 \qquad ( 1 a )$$

$$32. < vd\_BNn < 53. \qquad ( 2 a )$$

$$0.5108 < θCt\_BNn - 0.00417 \times vd\_BNn < 0.5508 \qquad ( 3 a )$$

It is more preferable that the inequalities (1a), (2a), and (3a) are further limited as follows.

$$1.69 < nd\_BNn < 1.87 \qquad ( 1 b )$$

$$32. < vd\_BNn < 52. \qquad ( 2 b )$$

$$0.5208 < θCt\_BNn - 0.00417 \times vd\_BNn < 0.5508 \qquad ( 3 b )$$

In order to miniaturize the entire system of the zoom lens, the total number of lens units constituting the zoom lens of the exemplary embodiments is five or less. The zoom lens according to the exemplary embodiments includes in order from the object side to the image side, two or less lens units having negative refractive powers and a lens unit having a positive refractive power.

Further, in order to secure a wide angle of view while downsizing the entire system, it is preferable to dispose a lens unit having a strong negative refractive power on the object side as much as possible, and such a strong negative lens unit greatly contributes to the generation of various aberrations such as curvature of field and chromatic aberration of magnification. Therefore, the lens unit BN is a lens unit having the largest (strongest) negative refractive power among the negative lens units (the one or more lens units having negative refractive powers) disposed in the object side of the lens unit having a positive refractive power disposed at the most object side. By defining the negative lens BNn as the inequalities (1), (2), and (3), the occurrence of various aberrations is suppressed.

Furthermore, in order to reduce various aberrations in the entire zoom range, it is effective to reduce the curvature of each negative lens by providing a plurality of negative lenses included in the lens unit BN. When the number of negative lenses included in the lens unit BN is large, the amount of various aberrations generated is easily reduced, but it is difficult to realize the miniaturization of the entire system. Therefore, in order to achieve both suppression of various aberrations and miniaturization, the number of negative lenses included in the lens unit BN is set to be two or more and four or less.

The lens unit BN includes at least one positive lens BNp satisfying the following inequality (4),

$$20.2 < vd\_BNp < 40.0 \qquad ( 4 )$$

where, vd_BNp represents the Abbe number of the positive lens BNp.

The inequality (4) defines a range of Abbe numbers of the positive lens BNp. Since the lens unit BN has a negative refractive power as a whole, it is desirable that the positive lens included in the lens unit BN has high dispersion in order to reduce chromatic aberration. If the value exceeds the upper limit of the inequality (4), the positive lens BNP becomes too low in dispersion, so that the chromatic aberration of magnification in the visible region deteriorates, which is not preferable. If the value falls below the lower limit of the inequality (4), since a glass material having a small refractive index in the near-infrared region with respect to the visible region is selected, the chromatic aberration of magnification in the near-infrared region with respect to the visible region deteriorates when the chromatic aberration of magnification in the visible region is corrected, which is not preferable.

It is preferable to limit the inequality (4) as follows.

$$23. 0 < vd\_BNp < 38. \qquad ( 4 a )$$

It is more preferable to further limit the inequality (4a) as follows.

$$24. < vd\_BNp < 37.5 \qquad ( 4 b )$$

When The following inequality (5) is satisfied,

$$0.5 < \vert f\_BN / D\_BN \vert < 3. \qquad ( 5 )$$

where D_BN represents the distance on the optical axis from the lens surface closest to the object side to the lens surface closest to the image side in the lens unit BN and f_BN represents the focal length of the lens unit BN.

The inequality (5) is for achieving miniaturization of the entire system and widening of the angle of view. If the value exceeds the upper limit of the inequality (5), the absolute value of the refractive power of the lens unit BN becomes too small, which makes it difficult to widen the angle of view. When the value falls below the lower limit value of the inequality (5), the thickness of the lens unit BN increases, which makes it difficult to miniaturize the entire system.

It is preferable to limit the inequality (5) as follows.

$$23. < \vert f\_BN / D\_BN \vert < 2.6 \qquad ( 5 a )$$

It is more preferable to further limit the inequality (5a) as follows.

$$0.5 < \vert f\_BN / D\_BN \vert < 2.3 \qquad ( 5 b )$$

A lens unit disposed at the most object side among lens units having three or more lenses and having positive refractive power is a lens unit BP (BP lens unit), and the lens unit BP includes at least one negative lens BPn (BP negative lens) satisfying the following inequalities (6), (7), and (8).

$$1.4 < nd\_BPn < 2 \text{.00} \qquad ( 6 )$$

$$15. < vd\_BPn < 61. \qquad ( 7 )$$

$$0.5408 < θ Ct\_BPn - 0.00 \; 528 \times ν d\_BPn < 0.5808 \qquad ( 8 )$$

where nd_BPn, vd_BPn and θCt_BPn respectively represent the refractive index, Abbe number, and partial dispersion ratio of the negative lens BPn.

The inequality (6) defines a range of the refractive index of the negative lens BPn. If the value exceeds the upper limit value of inequality (6), there is substantially no choice of glass material. If the value falls below the lower limit of the inequality (6), the refractive index of the glass material is too small, so that the curvature becomes large in order to maintain the refractive power of the negative lens BPn, and various aberrations deteriorate, which is not preferable.

The inequality (7) defines a range of Abbe numbers of the negative lens BPn. Since the lens unit BP has a positive refractive power as a whole, it is desirable that the negative lens included in the lens unit BP has low dispersion in order to reduce chromatic aberration. If the upper limit of the inequality (7) is exceeded, the positive lens will be too highly dispersed, resulting in worsening of axial chromatic aberration in the visible range, which is not preferable. When the value falls below the lower limit value of the inequality (7), since a glass material having a small refractive index in the near-infrared region with respect to the visible region is selected, when the axial chromatic aberration in the visible region is corrected, the axial chromatic aberration in the near-infrared region with respect to the visible region deteriorates, which is not preferable.

The inequality (8) defines a range of the partial dispersion ratio of the negative lens BPn. If the upper limit of inequality (8) is exceeded, there is substantially no choice of glass material. If the value falls below the lower limit of the inequality (8), the value of the partial dispersion ratio is too small, which makes it difficult to sufficiently correct the axial chromatic aberration in the near-infrared region, which is not preferable.

It is preferable to limit the inequalities (6), (7) and (8) as follows.

$$1.55 < nd\_BPn < 1.93 \qquad ( 6 a )$$

$$21. < vd\_BPn < 6 0. \qquad ( 7 a )$$

$$0.5408 < θ Ct\_BPn - 0.00 \; 528 \times ν d\_BPn < 0.5628 \qquad ( 8 a )$$

It is more preferable that the inequalities (6a), (7a) and (8a) are further limited as follows.

$$1.6 < nd\_BPn < 1.87 \qquad ( 6 b )$$

$$24. < vd\_BPn < 5 9. \qquad ( 7 b )$$

$$0.5408 < θ Ct\_BPn - 0.00 \; 528 \times ν d\_BPn < 0.5508 \qquad ( 8 b )$$

In order to achieve miniaturization while reducing various aberrations in the entire zoom range, the lens unit BP includes two or less negative lenses.

The lens unit BP includes at least one positive lens BPp satisfying the following inequality (9).

$$70.5 < vd\_BPp < 100.0 \qquad ( 9 )$$

where vd_BPp represents the Abbe number of the positive lens BPp.

The inequality (9) defines a range of Abbe number of the positive lens BPp. Since the lens unit BP has a positive refractive power as a whole, it is desirable that the positive lens BPp included in the lens unit BP has low dispersion in order to reduce the chromatic aberration. If the upper limit of inequality (9) is exceeded, there is substantially no choice of glass material. If the value falls below the lower limit of the inequality (9), the positive lens BPp becomes too highly dispersed, which is not preferable because the axial chromatic aberration in the visible region deteriorates.

It is preferable to limit the inequality (9) as follows.

$$75. < vd\_BPp < 98.0 \qquad ( 9 a )$$

It is more preferable to further limit the inequality (9a) as follows.

$$81.5 < vd\_BPp < 95. \qquad ( 9 b )$$

The lens unit BP has a zooming effect and moves toward the object side during zooming from the wide angle end to the telephoto end, thereby realizing miniaturization of the entire system while reducing various aberrations. In the present specification, the wide-angle end and the telephoto end refer to zoom positions when an optical system that moves for zooming is positioned at either end of the range where the optical system can be moved in a direction along the optical axis in terms of the mechanism.

Hereinafter, preferred embodiments of the present invention will be described in detail with reference to the accompanying drawings.

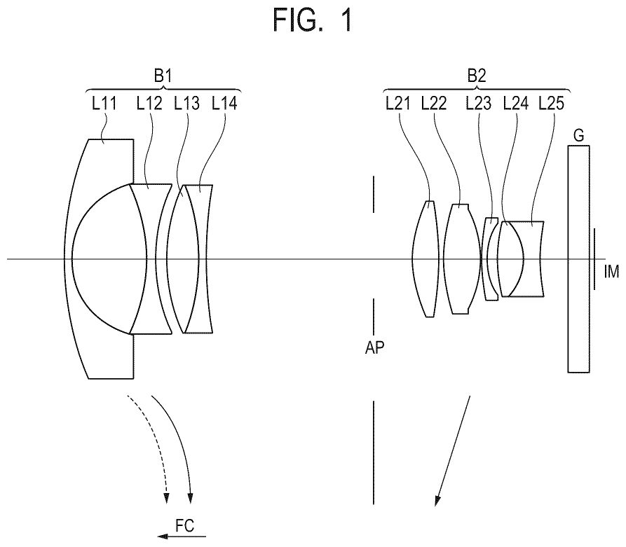

FIGS. 1, 3, 5, 7, 9, 11 and 13 are lens cross-sectional views of zoom lenses at the wide-angle end of Numerical Embodiments 1 to 7 described later. In each lens cross-sectional view, B1 to B5 denote first to fifth lens units, FC denotes a focus lens unit, AP denotes an aperture stop, G denotes a cover glass of a CCD or CMOS, a glass block such as a low pass filter or an IR (infrared light) cut filter, and IM denotes an image plane.

Arrows in the lens cross-sectional views indicate movement loci of the lens units during zooming from the wide-angle end to the telephoto end. Focusing from infinity to a short distance is performed by moving the focus lens unit on the optical axis in a direction indicated by an arrow FC in the left-and-right directions in the drawing. Among the movement loci of the lens units in the lens cross-sectional views, a solid curve indicates a movement locus for correcting image plane fluctuations accompanying zooming from the wide angle end to the telephoto end when focused on an object at infinity and a dotted curve indicates a movement locus when focused on an object at a short distance. In addition, the aperture stop AP is fixed in Numerical Embodiments 1 and 2, and moves during zooming from the wide angle end to the telephoto end in the direction indicated by the arrow in Numerical Embodiments 3, 4, 5, 6 and 7.

In some cases, the monitoring camera or the like switches between the daytime imaging mode and the nighttime imaging mode. The IR cut filter may be inserted and removed by an insertion/removal mechanism (not shown) according to the imaging mode, or the IR cut filter may be switched to another filter (for example, a filter that cuts visible light) by a switching mechanism (not shown).

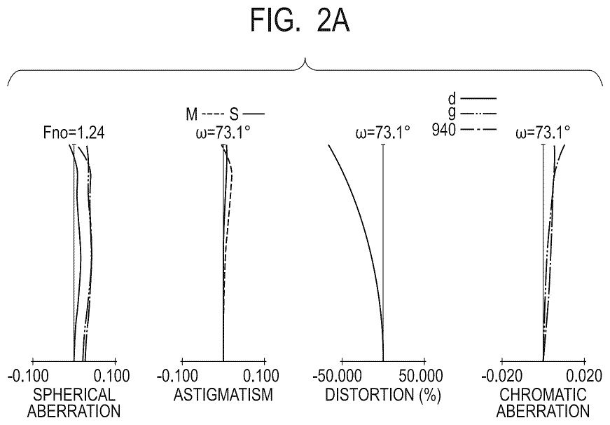

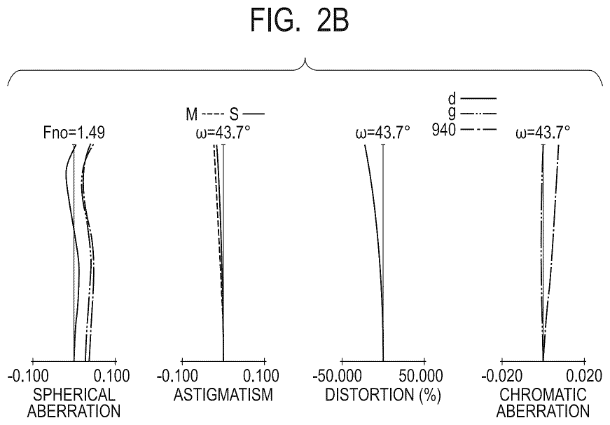

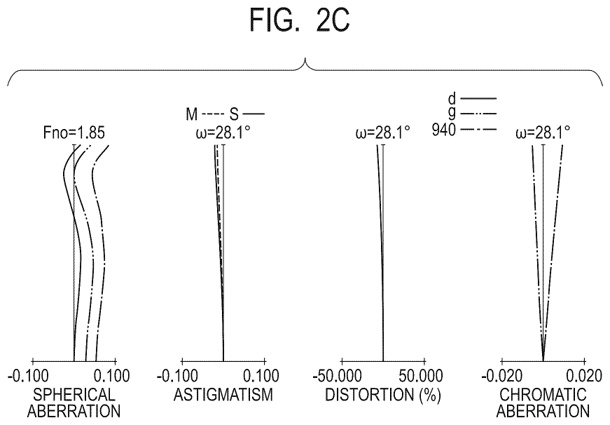

FIGS. 2A, 2B, 2C, 4A, 4B, 4C, 6A, 6B, 6C, 8A, 8B, 8C, 10A, 10B, 10C, 12A, 12B, 12C, 14A, 14B and 14C are aberration diagrams at the wide-angle end (A), the intermediate focal length (B), and the telephoto end (C) of Numerical Embodiments 1-7, respectively.

In the aberration diagrams, d, g, and 940 represent a d-line, a g-line, and a wavelength of 940 nm, M and S represent a meridional image plane and a sagittal image plane, and distortion is indicated by the d-line and chromatic aberration of magnification is indicated by the g-line, and the wavelength of 940 nm.

Numerical data of the numerical embodiments of the present invention are described in Numerical Embodiments 1 to 7.

In each of the numerical embodiments, the paraxial curvature radius r (mm) of each surface in order from the object side, the distance d (mm) between each surface and the next surface, the refractive index nd of each glass material with respect to the d-line, the Abbe number vd, and the partial dispersion ratio θCt are described.

The surface denoted by * on the right side of the surface number has an aspheric shape expressed by the following expression.

$$z = \frac{\frac{{y}^{2}}{r}}{1 + \sqrt{1 - ( 1 + k ) {( \frac{y}{r} )}^{2}}} + {\sum }_{j = I}^{16} {B}_{j} {y}^{j}$$

where y represents a distance in the radial direction from the optical axis, z represents a sag amount of a surface in the optical axis direction, r represents a paraxial radius of curvature, and k represents a conic coefficient. The sign of z is positive in the direction from the object side to the image plane.

In each numerical embodiment, “E±x” means “×10^{±x}”. In addition, all coefficients not particularly indicated are 0.

### Embodiment 1

FIG. 1 is a cross-sectional view of a zoom lens according to Embodiment 1 when focused on an object at infinity at the wide-angle end.

The zoom lens of Embodiment 1 includes, in order from the object side to the image side, a first lens unit B1 having a negative refractive power, an aperture stop AP, and a second lens unit B2 having a positive refractive power. During zooming, the interval between the adjacent lens units and the aperture stop AP changes.

The first lens unit B1 includes, in order from the object side to the image side, a negative lens L11, a negative lens L12, a positive lens L13, and a negative lens L14. The second lens unit B2 includes, in order from the object side to the image side, a positive lens L21, a positive lens L22, a negative lens L23, a positive lens L24, and a negative lens L25.

During zooming from the wide angle end to the telephoto end, the first lens unit B1 moves toward the image side, and the second lens unit B2 moves toward the object side. The aperture stop AP does not move for zooming. During focusing from infinity to a close distance, the first lens unit B1 moves toward the object side.

In the zoom lens according to Embodiment 1, the first lens unit B1 is the lens unit BN having a negative refractive power, and the negative lens L11 is the negative lens BNn. The second lens unit B2 is the lens unit BP, each of the negative lenses L23 and L25 is the negative lens BPn, and each of the positive lenses L21 and L22 is the positive lens BPp.

Table 1 shows the relationship between various numerical values in Numerical Embodiment 1 corresponding to Embodiment 1 and the inequalities (1) to (9).

The inequalities (1), (2) and (3) indicate values of the negative lens L11. The inequality (4) indicates a value of the positive lens L13. The inequality (5) indicates a value calculated for the first lens unit B1. In inequalities (6), (7) and (8), values for the negative lens L25 are shown. The inequality (9) indicates a value of the positive lens L22. The zoom lens of Numerical Embodiment 1 satisfies all the inequalities.

FIGS. 2A, 2B and 2C are aberration diagrams of the zoom lens of Numerical Embodiment 1 at the wide-angle end (A), the intermediate focal length (B), and the telephoto end (C), respectively. It can be seen that the aberrations are satisfactorily corrected in the zoom lens of Numerical Embodiment 1.

As described above, the zoom lens of Numerical Embodiment 1 realizes a zoom lens having a small size and a wide angle of view in which aberrations are satisfactorily corrected over a wide wavelength range from the visible region to the near-infrared region in the entire zoom range.

### Embodiment 2

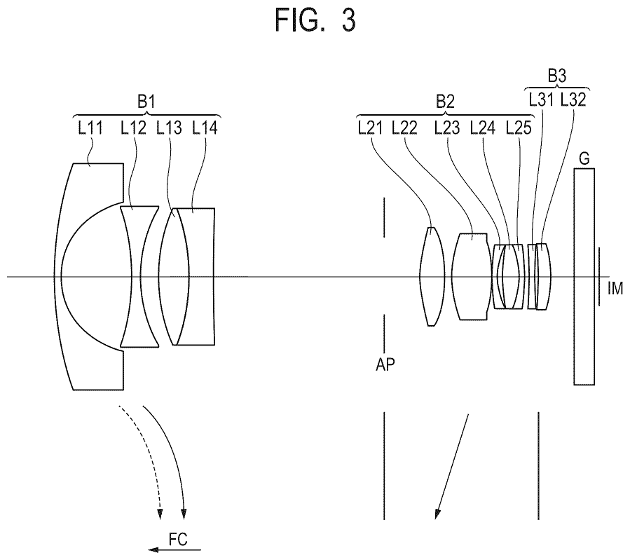

FIG. 3 is a cross-sectional view of the zoom lens according to Embodiment 2 when focused on an object at infinity at the wide-angle end.

The zoom lens of Embodiment 2 includes, in order from the object side to the image side, a first lens unit B1 having a negative refractive power, an aperture stop AP, a second lens unit B2 having a positive refractive power, and a third lens unit B3 having a negative refractive power. During zooming, the interval between the adjacent lens units and the aperture stop AP changes.

The first lens unit B1 includes, in order from the object side to the image side, a negative lens L11, a negative lens L12, a positive lens L13, and a negative lens L14. The second lens unit B2 includes, in order from the object side to the image side, a positive lens L21, a positive lens L22, a negative lens L23, a positive lens L24, and a negative lens L25. The third lens unit B3 includes, in order from the object side to the image side, a negative lens L31 and a positive lens L32.

During zooming from the wide angle end to the telephoto end, the first lens unit B1 moves toward the image side, and the second lens unit B2 moves toward the object side. The aperture stop AP and the third lens unit B3 do not move for zooming. During focusing from infinity to a close distance, the first lens unit B1 moves toward the object side.

In the zoom lens according to Embodiment 2, the first lens unit B1 is the lens unit BN having a negative refractive power, and the negative lens L11 is the negative lens BNn. The second lens unit B2 is the lens unit BP, each of the negative lenses L23 and L25 is the negative lens BPn, and each of the positive lenses L21 and L22 is the positive lens BPp.

Table 1 shows the relationship between various numerical values in Numerical Embodiment 2 corresponding to Embodiment 2 and the inequalities (1) to (9).

The inequalities (1), (2) and (3) indicate values of the negative lens L11. The inequality (4) indicates a value of the lens L13. The inequality (5) indicates a value calculated for the first lens unit B1. In inequalities (6), (7) and (8), values for the negative lens L23 are shown. The inequality (9) indicates a value of the positive lens L22.

The zoom lens of Numerical Embodiment 2 satisfies all the inequalities (1) to (9).

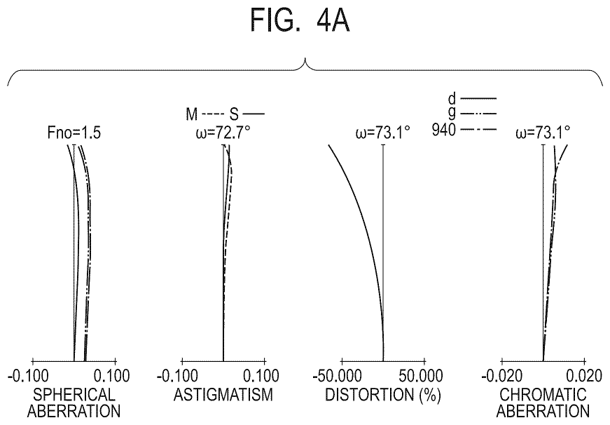

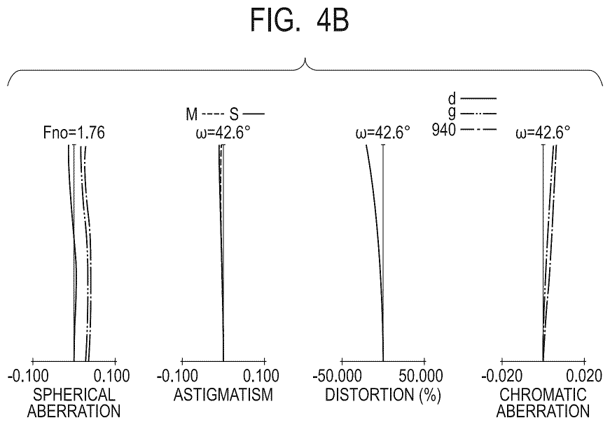

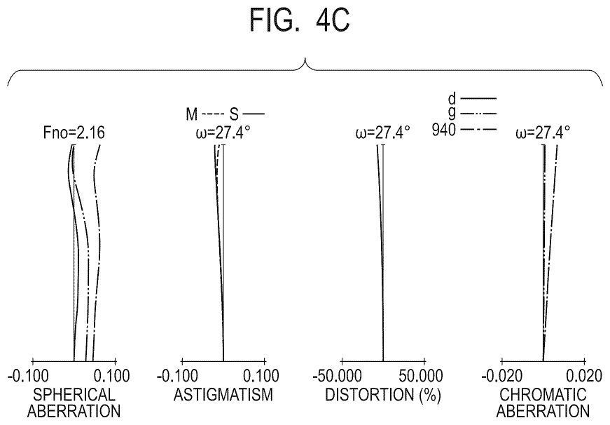

FIGS. 4A, 4B and 4C are aberration diagrams of the zoom lens of Numerical Embodiment 2 at the wide-angle end (A), the intermediate focal length (B), and the telephoto end (C), respectively. It can be seen that aberrations are satisfactorily corrected in the zoom lens of Numerical Embodiment 2.

As described above, the zoom lens of Numerical Embodiment 2 realizes a zoom lens having a small size and a wide angle of view in which aberrations are satisfactorily corrected over a wide wavelength range from the visible region to the near-infrared region in the entire zoom range.

### Embodiment 3

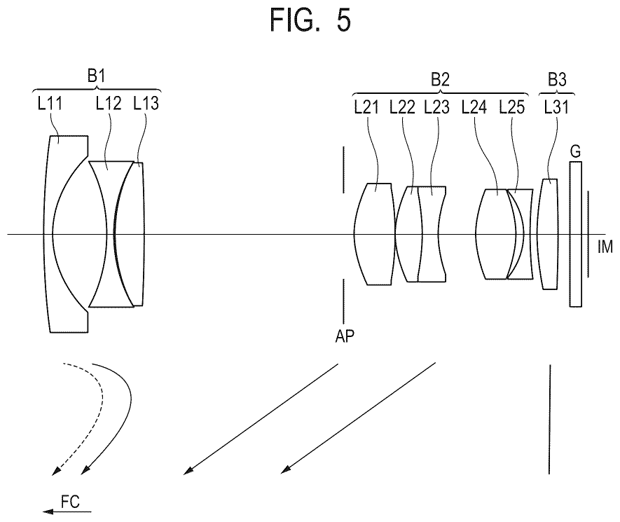

FIG. 5 is a cross-sectional view of the zoom lens according to Embodiment 3 at the wide-angle end when focused on an object at infinity.

The zoom lens of Embodiment 3 includes, in order from the object side to the image side, a first lens unit B1 having a negative refractive power, an aperture stop AP, a second lens unit B2 having a positive refractive power, and a third lens unit B3 having a positive refractive power. During zooming, the interval between the adjacent lens units and the aperture stop AP changes.

The first lens unit B1 includes, in order from the object side to the image side, a negative lens L11, a negative lens L12, and a positive lens L13. The second lens unit B2 includes, in order from the object side to the image side, a positive lens L21, a positive lens L22, a negative lens L23, a positive lens L24, and a negative lens L25. The third lens unit B3 includes a positive lens L31.

During zooming from the wide angle end to the telephoto end, the first lens unit B1 moves toward the object side after moving toward the image side, and the aperture stop AP and the second lens unit B2 move toward the object side. The third lens unit B3 does not move for zooming. During focusing from infinity to a close distance, the first lens unit B1 moves toward the object side.

In the zoom lens according to Embodiment 3, the first lens unit B1 is the lens unit BN having a negative refractive power, and the negative lens L12 is the negative lens BNn. The second lens unit B2 is the lens unit BP, each of the negative lenses L23 and L25 is the negative lens BPn, and each of the positive lenses L21, L22, and L24 is the positive lens BPp.

Table 1 shows the relationship between various numerical values in Numerical Embodiment 3 corresponding to Embodiment 3 and the inequalities (1) to (9).

The inequalities (1), (2) and (3) indicate values of the negative lens L12. The inequality (4) indicates a value of the positive lens L13. The inequality (5) indicates a value calculated for the first lens unit B1. In inequalities (6), (7) and (8), values for the negative lens L25 are shown. The inequality (9) indicates a value of the positive lens L22.

The zoom lens of Numerical Embodiment 3 satisfies all the inequalities (1) to (9).

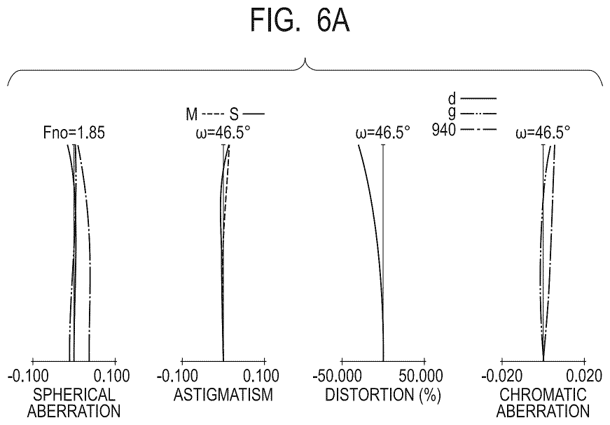

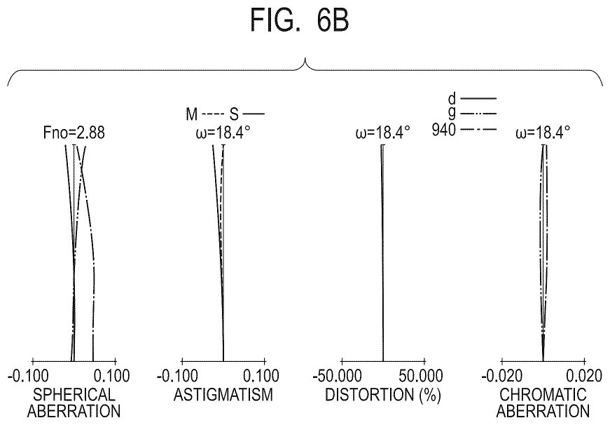

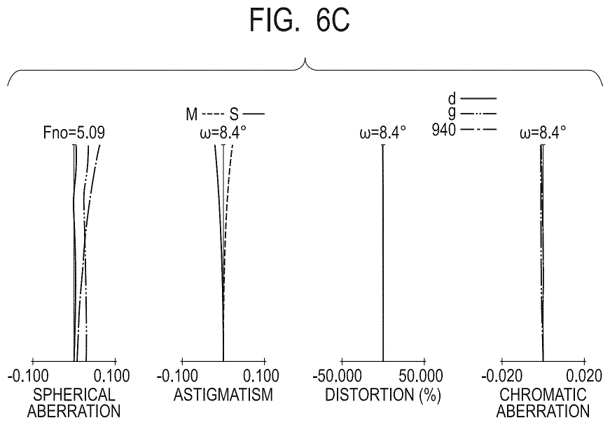

FIGS. 6A, 6B and 6C are aberration diagrams of the zoom lens of Numerical Embodiment 3 at the wide-angle end (A), the intermediate focal length (B), and the telephoto end (C), respectively. It can be seen that the aberrations are satisfactorily corrected in the zoom lens of Numerical Embodiment 3.

As described above, the zoom lens of Numerical Embodiment 3 realizes a zoom lens having a small size and a wide angle of view in which aberrations are satisfactorily corrected over a wide wavelength range from the visible region to the near-infrared region in the entire zoom range.

### Embodiment 4

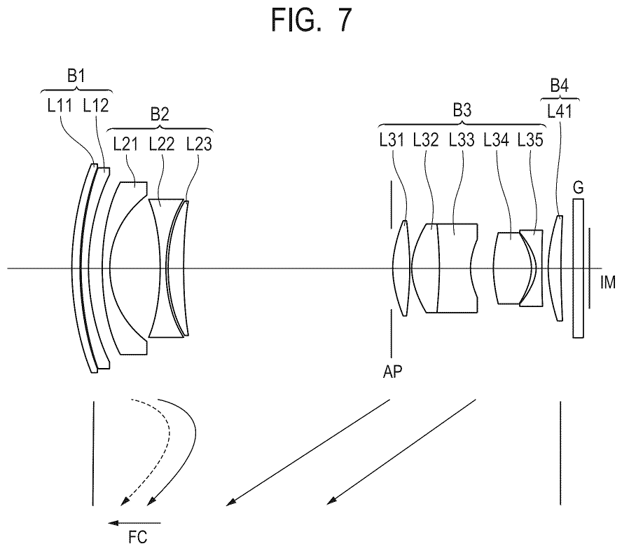

FIG. 7 is a cross-sectional view of the zoom lens according to Embodiment 4 at the wide-angle end when focused on an object at infinity.

The zoom lens of Embodiment 4 includes, in order from the object side to the image side, a first lens unit B1 having a negative refractive power, a second lens unit B2 having a negative refractive power, an aperture stop AP, a third lens unit B3 having a positive refractive power, and a fourth lens unit B4 having a positive refractive power. During zooming, the interval between the adjacent lens units and the aperture stop AP changes.

The first lens unit B1 includes, in order from the object side to the image side, a negative lens L11 and a negative lens L12. The second lens unit B2 includes, in order from the object side to the image side, a negative lens L21, a negative lens L22, and a positive lens L23. The third lens unit B3 includes, in order from the object side to the image side, a positive lens L31, a positive lens L32, a negative lens L33, a positive lens L34, and a negative lens L35. The fourth lens unit B4 includes a positive lens L41.

During zooming from the wide angle end to the telephoto end, the second lens unit B2 moves toward the object side after moving toward the image side, and the aperture stop AP and the third lens unit B3 move toward the object side. The first lens unit B1 and the fourth lens unit B4 do not move for zooming. During focusing from infinity to a close distance, the second lens unit B2 moves toward the object side.

In the zoom lens according to Embodiment 4, the second lens unit B2 is the lens unit BN having a negative refractive power, and the negative lens L21 is the negative lens BNn. The third lens unit B3 is the lens unit BP, each of the negative lenses L33 and L35 is the negative lens BPn, and each of the positive lenses L31, L32 and L34 is the positive lens BPp.

Table 1 shows the relationship between various numerical values in Numerical Embodiment 4 corresponding to Embodiment 4 and the inequalities (1) to (9).

The inequalities (1), (2) and (3) indicate values of the negative lens L21. The inequality (4) indicates a value of the positive lens L23. The inequality (5) indicates a value calculated for the second lens unit B2. In inequalities (6), (7) and (8), values for the negative lens L35 are shown. The inequality (9) indicates a value of the positive lens L32. The zoom lens of Numerical Data Embodiment 4 satisfies all the inequalities (1) to (9).

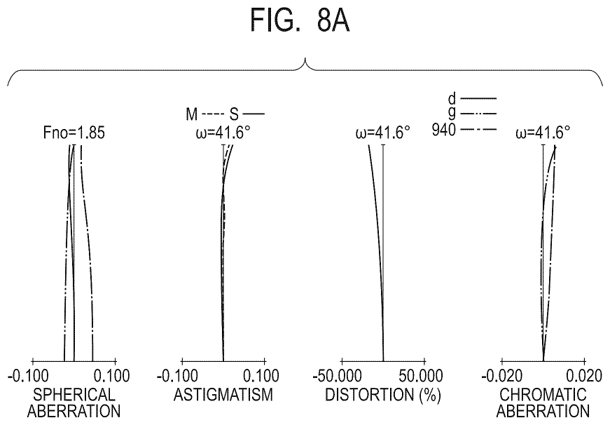

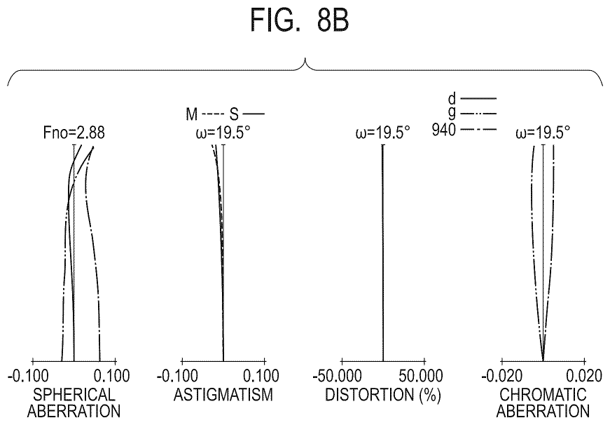

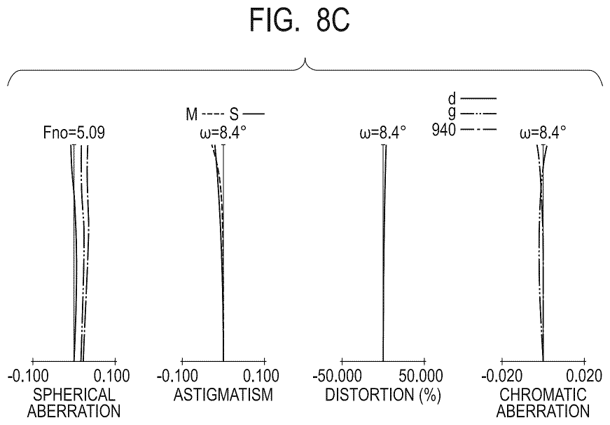

FIGS. 8A, 8B and 8C are aberration diagrams of the zoom lens of Numerical Embodiment 4 at the wide-angle end (A), the intermediate focal length (B), and the telephoto end (C), respectively. It can be seen that the aberrations are satisfactorily corrected in the zoom lens of Numerical Embodiment 4.

As described above, the zoom lens of Numerical Embodiment 4 realizes a zoom lens having a small size and a wide angle of view in which aberrations are satisfactorily corrected over a wide wavelength range from the visible region to the near-infrared region in the entire zoom range.

### Embodiment 5

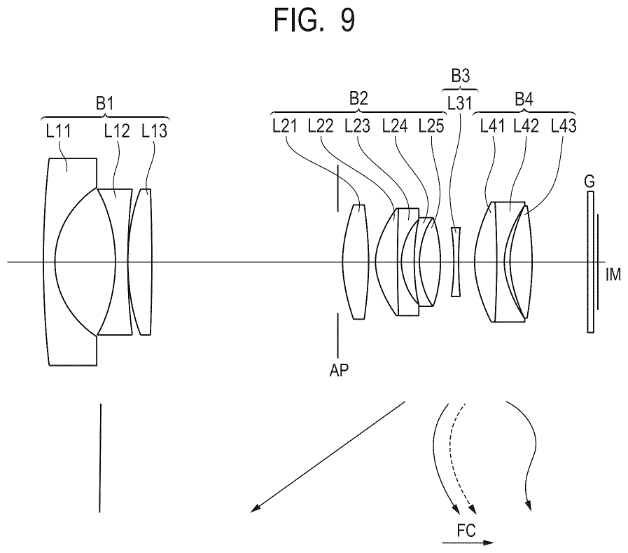

FIG. 9 is a cross-sectional view of a zoom lens according to Embodiment 5 when focused on an object at infinity at a wide angle end.

The zoom lens of Embodiment 5 includes, in order from the object side to the image side, a first lens unit B1 having a negative refractive power, a second lens unit B2 having a positive refractive power, a third lens unit B3 having a negative refractive power, and a fourth lens unit B4 having a positive refractive power. During zooming, the interval between adjacent lens units changes.

The first lens unit B1 includes, in order from the object side to the image side, a negative lens L11, a negative lens L12, and a positive lens L13. The second lens unit B2 includes, in order from the object side to the image side, an aperture stop AP, a positive lens L21, a positive lens L22, a negative lens L23, a negative lens L24, and a positive lens L25. The third lens unit B3 includes a negative lens L31. The fourth lens unit B4 includes, in order from the object side to the image side, a positive lens L41, a negative lens L42, and a positive lens L43.

During zooming from the wide angle end to the telephoto end, the second lens unit B2 moves toward the object side, the third lens unit B3 moves toward the object side, then moves toward the image side, and the fourth lens unit B4 moves. The first lens unit B1 does not move for zooming. During focusing from infinity to a close distance, the third lens unit B3 moves toward the image side.

In the zoom lens according to Embodiment 5, the first lens unit B1 is the lens unit BN having a negative refractive power, and the negative lens L11 is the negative lens BNn. The second lens unit B2 is the lens unit BP, the negative lens L24 is the negative lens BPn, and each of the positive lenses L22 and L25 is the positive lens BPp.

Table 1 shows the relationship between various numerical values in Numerical Embodiment 5 corresponding to Embodiment 5 and the inequalities (1) to (9).

The inequalities (1) (2), and (3) indicate values of the negative lens L11. The inequality (4) indicates a value of the positive lens L13. The inequality (5) indicates a value calculated for the first lens unit B1. In inequalities (6), (7) and (8), values for the negative lens L24 are shown. The inequality (9) indicates a value of the positive lens L22.

The zoom lens of Numerical Embodiment 5 satisfies all the inequalities (1) to (9).

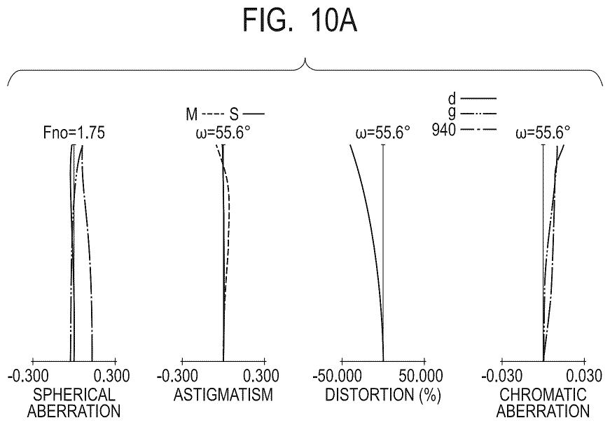

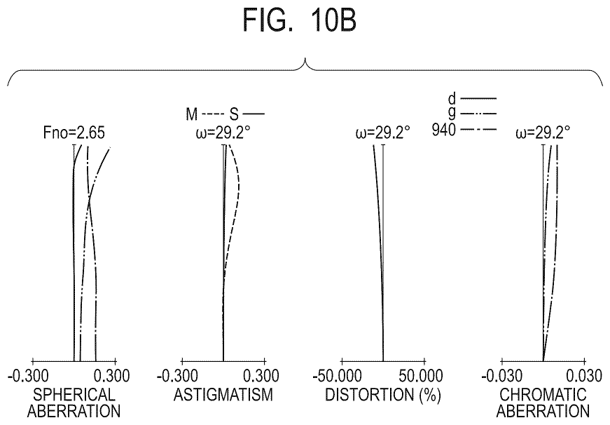

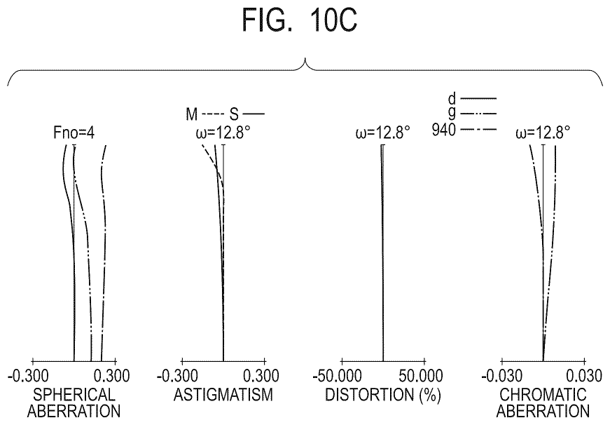

FIGS. 10A, 10B and 10C are aberration diagrams of the zoom lens of Numerical Embodiment 5 at the wide-angle end (A), the intermediate focal length (B), and the telephoto end (C), respectively. It can be seen that the aberrations are satisfactorily corrected in the zoom lens of Numerical Embodiment 5.

As described above, the zoom lens of Numerical Embodiment 5 realizes a zoom lens having a small size and a wide angle of view in which aberrations are satisfactorily corrected over a wide wavelength range from the visible region to the near-infrared region in the entire zoom range.

### Embodiment 6

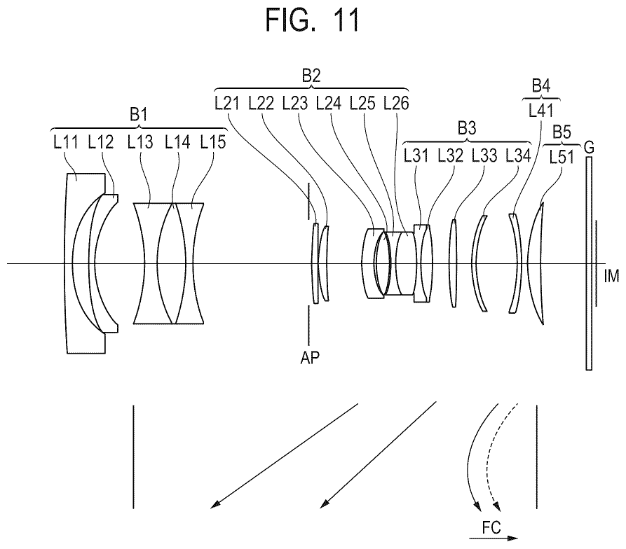

FIG. 11 is a cross-sectional view of the zoom lens according to Embodiment 6 at the wide-angle end when focused on an object at infinity.

The zoom lens of Embodiment 6 includes, in order from the object side to the image side, a first lens unit B1 having a negative refractive power, a second lens unit B2 having a positive refractive power, a third lens unit B3 having a negative refractive power, a fourth lens unit B4 having a negative refractive power, and a fifth lens unit B5 having a positive refractive power. During zooming, the interval between adjacent lens units changes.

The first lens unit B1 includes, in order from the object side to the image side, a negative lens L11, a negative lens L12, a negative lens L13, a positive lens L14, and a negative lens L15. The second lens unit B2 includes, in order from the object side to the image side, an aperture stop AP, a positive lens L21, a positive lens L22, a negative lens L23, a positive lens L24, a negative lens L25, and a positive lens L26. The third lens unit B3 includes, in order from the object side to the image side, a negative lens L31 and positive lenses L32, L33, and L34. The fourth lens unit B4 includes a negative lens L41. The fifth lens unit B5 includes a positive lens L51.

During zooming from the wide angle end to the telephoto end, the second lens unit B2 moves toward the object side, the third lens unit B3 moves toward the object side, and the fourth lens unit B4 moves toward the image side after moving toward the object side. The first lens unit B1 and the fifth lens unit B5 do not move for zooming. During focusing from infinity to a close distance, the fourth lens unit B4 moves toward the image side.

In the zoom lens according to Embodiment 6, the first lens unit B1 is the lens unit BN having a negative refractive power, and the negative lens L11 is the negative lens BNn. The second lens unit B2 is the lens unit BP, each of the negative lenses L23 and L25 is the negative lens BPn, and each of the positive lenses L24 and L26 is the positive lens BPp.

Table 1 shows the relationship between various numerical values in Numerical Embodiment 6 corresponding to Embodiment 6 and the inequalities (1) to (9).

The inequalities (1), (2) and (3) indicate values of the negative lens L11. The inequality (4) indicates a value of the lens L14. The inequality (5) indicates a value calculated for the first lens unit B1. In inequalities (6), (7) and (8), values of the negative lens L23 are shown. The inequality (9) indicates a value of the positive lens L24. The zoom lens of Numerical Data Embodiment 6 satisfies all the inequalities (1) to (9).

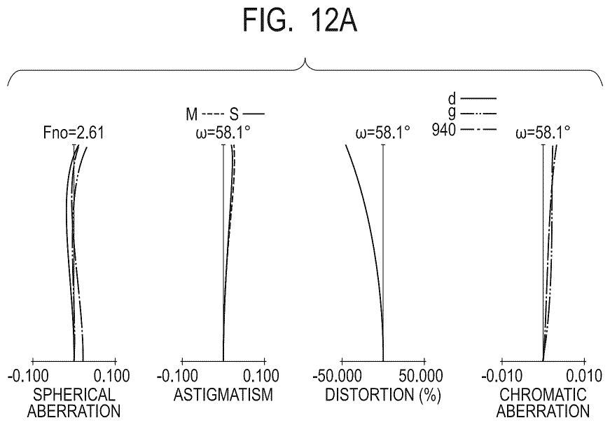

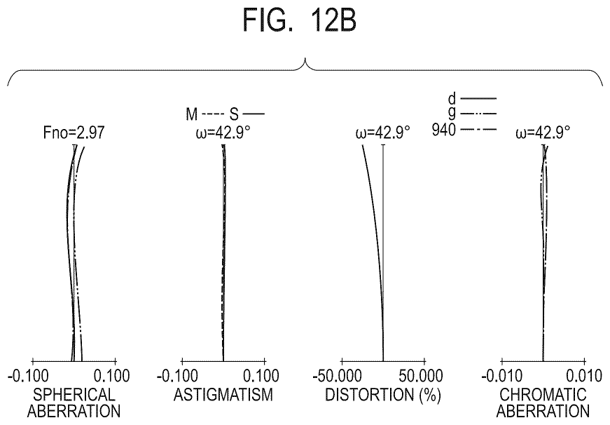

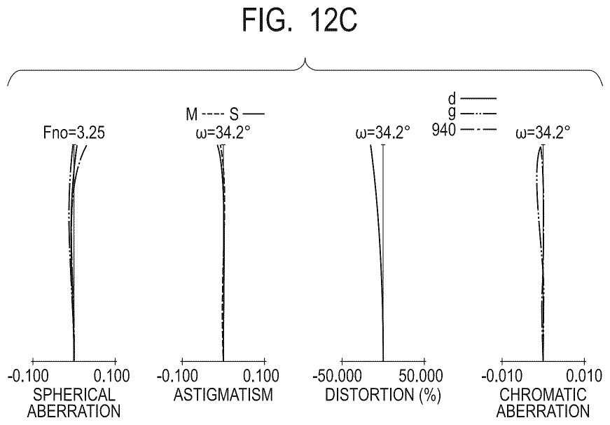

FIGS. 12A, 12B and 12C are aberration diagrams of the zoom lens of Numerical Embodiment 6 at the wide-angle end (A), the intermediate focal length (B), and the telephoto end (C), respectively. It can be seen that the aberrations are satisfactorily corrected in the zoom lens of Numerical Embodiment 6.

As described above, the zoom lens of Numerical Embodiment 6 realizes a zoom lens having a small size and a wide angle of view in which aberrations are satisfactorily corrected over a wide wavelength range from the visible region to the near-infrared region in the entire zoom range.

### Embodiment 7

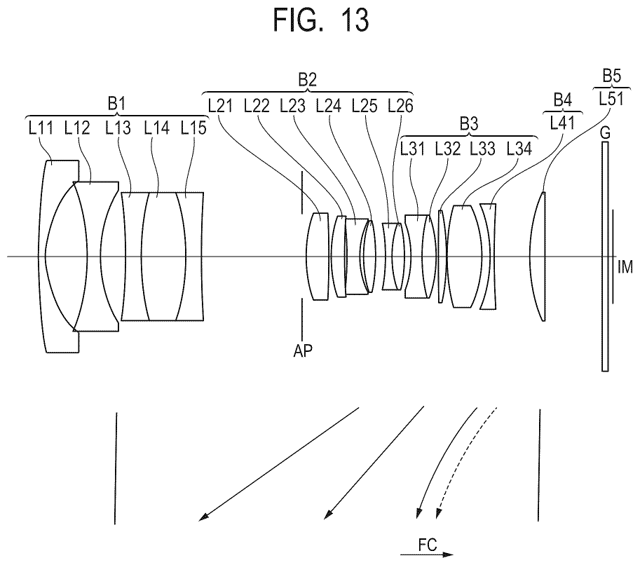

FIG. 13 is a cross-sectional view of the zoom lens according to Embodiment 7 at the wide-angle end when focused on an object at infinity.

The zoom lens of Embodiment 7 includes, in order from the object side to the image side, a first lens unit B1 having a negative refractive power, a second lens unit B2 having a positive refractive power, a third lens unit B3 having a positive refractive power, a fourth lens unit B4 having a negative refractive power, and a fifth lens unit B5 having a positive refractive power. During zooming, the interval between adjacent lens units changes.

The first lens unit B1 includes, in order from the object side to the image side, a negative lens L11, a negative lens L12, a negative lens L13, a positive lens L14, and a negative lens L15. The second lens unit B2 includes, in order from the object side to the image side, a positive lens L21, a positive lens L22, a negative lens L23, a positive lens L24, a negative lens L25, and a positive lens L26. The third lens unit B3 includes, in order from the object side to the image side, a negative lens L31, a positive lens L32, a positive lens L33, and a positive lens L34. The fourth lens unit B4 includes a negative lens L41. The fifth lens unit B5 includes a positive lens L51.

During zooming from the wide angle end to the telephoto end, the second lens unit B2 moves toward the object side, the third lens unit B3 moves toward the object side, and the fourth lens unit B4 moves toward the object side. The first lens unit B1 and the fifth lens unit B5 do not move for zooming. During focusing from infinity to a close distance, the fourth lens unit B4 moves toward the image side.

In the zoom lens according to Embodiment 7, the first lens unit B1 is the lens unit BN having a negative refractive power, and the negative lens L11 is the negative lens BNn. The second lens unit B2 is the lens unit BP, each of the negative lenses L23 and L25 is the negative lens BPn, and each of the positive lenses L24 and L26 is the positive lens BPp.

Table 1 shows the relationship between various numerical values in Numerical Embodiment 7 corresponding to Embodiment 7 and the inequalities (1) to (9).

The inequalities (1), (2) and (3) indicate values of the negative lens L11. The inequality (4) indicates a value of the positive lens L14. The inequality (5) indicates a value calculated for the first lens unit B1. In inequalities (6), (7) and (8), values of the negative lens L23 are shown. The inequality (9) indicates a value of the positive lens L24.

The zoom lens of Numerical Embodiment 7 satisfies all the inequalities (1) to (9).

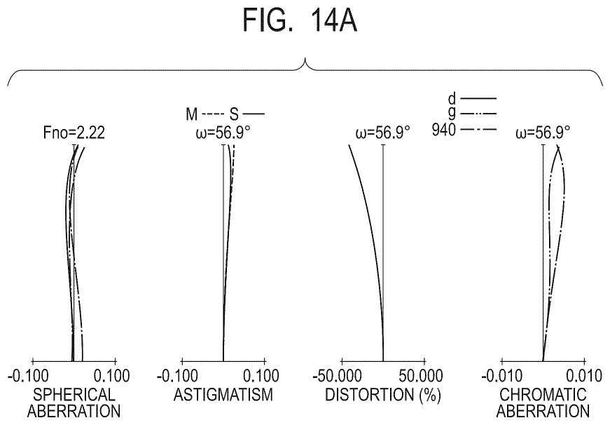

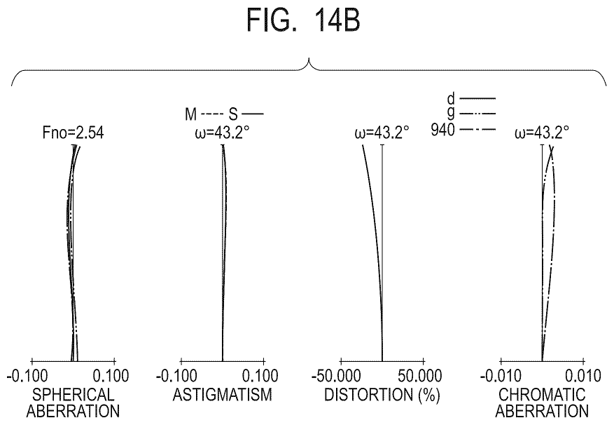

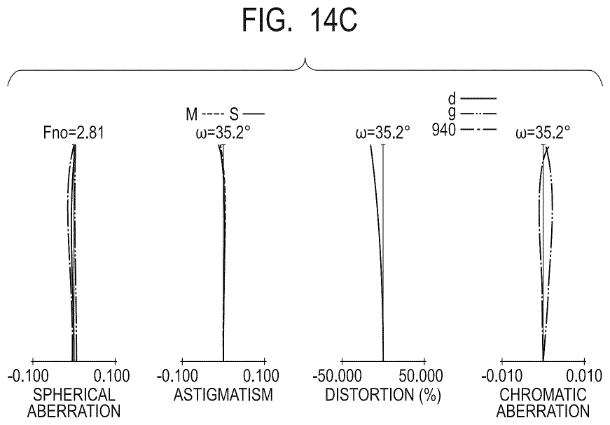

FIGS. 14A, 14B and 14C are aberration diagrams of the zoom lens of Numerical Embodiment 7 at the wide-angle end (A), the intermediate focal length (B), and the telephoto end (C), respectively. It can be seen that the aberrations are satisfactorily corrected in the zoom lens of Numerical Embodiment 7.

As described above, the zoom lens of Numerical Embodiment 7 realizes a zoom lens having a small size and a wide angle of view in which aberrations are satisfactorily corrected over a wide wavelength range from the visible region to the near-infrared region in the entire zoom range.

### (Imaging Device)

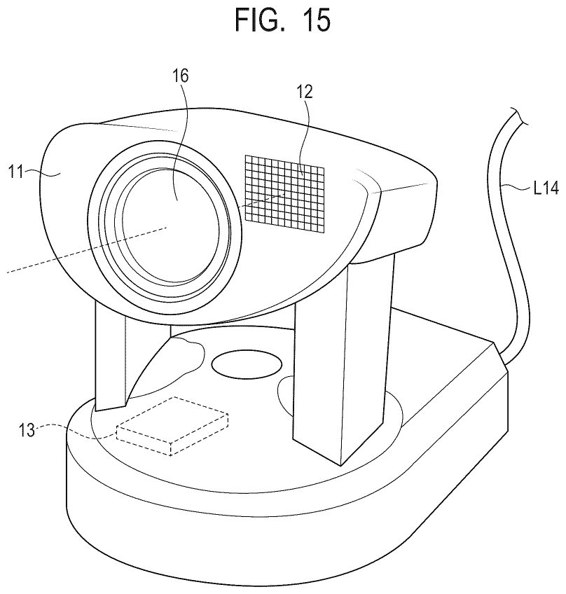

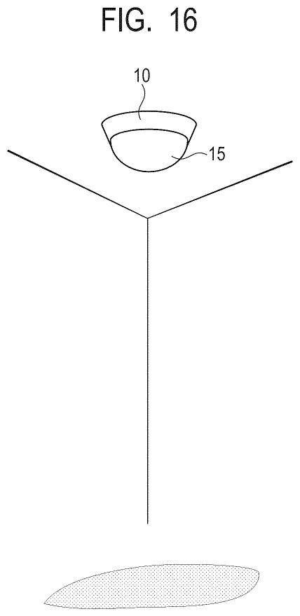

Next, an embodiment of an image pickup apparatus using the zoom lens as an image pickup optical system will be described with reference to FIGS. 15 and 16.

In FIGS. 15 and 16, reference numeral 16 denotes an image pickup optical system constituted by the zoom lens of the exemplary embodiment. Reference numerals 10 and 11 denote surveillance camera (imaging apparatus) main bodies, and reference numeral 12 denotes an image pickup element such as a CCD or CMOS that receives a subject image formed by the image pickup optical system 16. Reference numeral 13 denotes a recording unit for recording information corresponding to the subject image received by the image pickup element 12, reference numeral 14 denotes a transfer unit for transferring the information corresponding to the subject image received by the image pickup element 12, and reference numeral 15 denotes a cover for protecting the surveillance camera main body 11 and the image pickup optical system 16.

As described above, by applying the zoom lens of the exemplary embodiment to an image pickup apparatus such as a surveillance camera, it is possible to realize an image pickup apparatus having a small size and a wide angle of view in which aberrations are satisfactorily corrected over a wide wavelength range from the visible region to the near-infrared region in an entire zoom range.

The image pickup apparatus is not limited to a monitoring camera, and can be used in a video camera, a digital camera, or the like.

In addition to the above, the image pickup apparatus of the exemplary embodiment may include an aberration correction unit such as a circuit that electrically corrects aberrations.

Although preferred embodiments of the present invention have been described above, the present invention is not limited to these embodiments, and various modifications and changes can be made within the scope of the gist of the embodiments. For example, the number of lenses of each lens unit may be changed, the number of aspherical lenses may be increased, or the number of lens units of the subsequent group may be changed within a range satisfying the requirements.

### Numerical Embodiment 1

Unit mm
Surface data

| Surface | | | | | |
|---|---|---|---|---|---|
| number | r | d | nd | vd | θct |
| 1 | 29.721 | 0.70 | 1.85920 | 33.0 | 0.686 |
| 2 | 7.274 | 7.00 | | | |
| 3 | −16.563 | 0.90 | 1.49700 | 81.5 | 0.826 |
| 4 | 16.369 | 1.07 | | | |
| 5 | 17.278 | 3.00 | 1.73800 | 32.3 | 0.715 |
| 6 | −18.856 | 0.70 | 1.52841 | 76.5 | 0.818 |
| 7 | 37.024 | (Variable) | | | |
| 8 (Stop) | ∞ | (Variable) | | | |
| 9* | 9.154 | 2.52 | 1.55332 | 71.7 | 0.816 |
| 10* | −20.215 | 0.42 | | | |
| 11 | 15.422 | 3.50 | 1.43875 | 94.7 | 0.841 |
| 12 | −10.031 | 0.10 | | | |
| 13 | 19.606 | 0.49 | 1.85478 | 24.8 | 0.674 |
| 14 | 6.039 | 1.01 | | | |
| 15* | 12.915 | 2.43 | 1.76802 | 49.2 | 0.789 |
| 16 | −4.994 | 1.60 | 1.67300 | 38.3 | 0.748 |
| 17 | 19.706 | (Variable) | | | |
| 18 | ∞ | 1.96 | 1.51400 | 70.0 | |
| 19 | ∞ | 0.50 | | | |
| Image | ∞ | | | | |
| plane | | | | | |

Aspherical surface data
The ninth surface
K = 0.00000e+00 A 4 = −3.79778e−04 A 6 = −1.16991e−06
A 8 = −2.22422e−07
The tenth surface
K = 0.00000e+00 A 4 = 3.78175e−04 A 6 = −3.65070e−06
The fifteenth surface
K = 0.00000e+00 A 4 = −1.98800e−04 A 6 = −1.09240e−05

Various data

| | |
|---|---|
| Zoom ratio | 2.30 |

| | Wide | | Telephoto |
|---|---|---|---|
| | angle end | Intermediate | end |
| Focal length | 2.68 | 4.07 | 6.16 |
| F-number | 1.24 | 1.49 | 1.85 |
| Half angle of view | 73.09 | 43.69 | 28.13 |
| Image height | 3.04 | 3.04 | 3.04 |
| Total lens length | 49.38 | 40.72 | 36.27 |
| BF | 4.46 | 5.89 | 8.03 |
| d 7 | 15.81 | 7.14 | 2.70 |
| d 8 | 3.67 | 2.24 | 0.10 |
| d17 | 2.67 | 4.09 | 6.23 |

Zoom lens unit data

| | Leading | Focal |
|---|---|---|
| Unit | surface | length |
| 1 | 1 | −8.79 |
| 2 | 9 | 9.00 |

Single lens data

| | Leading | Focal |
|---|---|---|
| Lens | surface | length |
| 1 | 1 | −11.37 |
| 2 | 3 | −16.42 |
| 3 | 5 | 12.66 |
| 4 | 6 | −23.54 |
| 5 | 9 | 11.75 |
| 6 | 11 | 14.46 |
| 7 | 13 | −10.38 |
| 8 | 15 | 4.98 |
| 9 | 16 | −5.77 |

### Numerical Embodiment 2

Unit mm
Surface data

| Surface | | | | | |
|---|---|---|---|---|---|
| number | r | d | nd | vd | θct |
| 1 | 35.601 | 0.70 | 1.85920 | 33.0 | 0.686 |
| 2 | 7.631 | 7.00 | | | |
| 3 | −21.129 | 0.90 | 1.49700 | 81.5 | 0.826 |
| 4 | 13.533 | 1.76 | | | |
| 5 | 17.429 | 3.12 | 1.78880 | 28.4 | 0.694 |
| 6 | −20.334 | 2.36 | 1.83481 | 42.7 | 0.756 |
| 7 | 139.125 | (variable) | | | |
| 8(stop) | ∞ | (variable) | | | |
| 9* | 10.838 | 2.48 | 1.55332 | 71.7 | 0.816 |
| 10* | −13.130 | 0.67 | | | |
| 11 | 11.079 | 4.00 | 1.43875 | 94.7 | 0.841 |
| 12 | −13.213 | 0.10 | | | |
| 13 | 25.581 | 0.44 | 1.85478 | 24.8 | 0.674 |
| 14 | 5.534 | 0.60 | | | |
| 15 | 25.701 | 1.67 | 1.76385 | 48.5 | 0.769 |
| 16 | −7.634 | 0.50 | 1.73800 | 32.3 | 0.715 |
| 17 | −28.550 | (variable) | | | 5.640 |
| 18 | −23.690 | 0.50 | 1.65412 | 39.7 | 0.756 |
| 19 | 36.392 | 0.37 | | | |
| 20 | −25.682 | 1.23 | 1.85150 | 40.80 | 0.739 |
| 21 | −11.7260 | 2.44 | | | |
| 22 | ∞ | 1.96 | 1.51400 | 70.00 | |
| 23 | ∞ | 0.50 | | | |
| Image | ∞ | | | | |
| plane | | | | | |

Aspherical surface data
The ninth surface
K = 0.00000e+00 A 4 = −3.96779e−04 A 6 = −1.76656e−06
A 8 = −3.17779e−07
The tenth surface
K = 0.00000e+00 A 4 = 2.33037e−04 A 6 = −4.60764e−06
A 8 = −1.97114e−07

Various data

| | |
|---|---|
| Zoom ratio | 2.30 |

| | Wide | | Telephoto |
|---|---|---|---|
| | angle end | Intermediate | end |
| Focal length | 2.74 | 4.17 | 6.30 |
| F-number | 1.50 | 1.76 | 2.16 |
| Half angle of view | 72.72 | 42.57 | 27.40 |
| Image height | 3.04 | 3.04 | 3.04 |
| Total lens length | 53.87 | 44.24 | 39.16 |
| BF | 4.24 | 4.24 | 4.24 |
| d 7 | 17.07 | 7.44 | 2.36 |
| d 8 | 3.63 | 2.22 | 0.10 |
| d17 | 0.53 | 1.94 | 4.06 |

Zoom lens unit data

| | Leading | Focal |
|---|---|---|
| Unit | surface | length |
| 1 | 1 | −8.72 |
| 3 | 9 | 9.36 |
| 4 | 18 | −700.01 |

Single lens data

| | Leading | Focal |
|---|---|---|
| Lens | surface | length |
| 1 | 1 | −11.44 |
| 2 | 3 | −16.46 |
| 3 | 5 | 12.35 |
| 4 | 6 | −21.11 |
| 5 | 9 | 11.14 |
| 6 | 11 | 14.46 |
| 7 | 13 | −8.35 |
| 8 | 15 | 7.88 |
| 9 | 16 | −14.26 |
| 10 | 18 | −21.86 |
| 11 | 20 | 24.36 |

### Numerical Embodiment 3

Unit mm
Surface data

| Surface | | | | | |
|---|---|---|---|---|---|
| number | r | d | nd | vd | θct |
| 1 | 52.948 | 0.70 | 1.49700 | 81.5 | 0.826 |
| 2 | 7.674 | 4.00 | | | |
| 3 | −11.208 | 0.50 | 1.69930 | 51.1 | 0.760 |
| 4 | 10.502 | 0.10 | | | |
| 5 | 11.227 | 2.13 | 2.00330 | 28.3 | 0.684 |
| 6 | −134.899 | (variable) | | | |
| 7(stop) | ∞ | (variable) | | | |
| 8* | 7.080 | 2.99 | 1.55332 | 71.7 | 0.816 |
| 9* | −21.235 | 0.10 | | | |
| 10 | 7.704 | 1.94 | 1.49700 | 81.5 | 0.826 |
| 11 | −14.948 | 1.16 | 1.73800 | 32.3 | 0.715 |
| 12 | 7.791 | 2.75 | | | |
| 13* | 7.514 | 3.00 | 1.55332 | 71.7 | 0.816 |
| 14* | −8.856 | 0.56 | | | |
| 15 | −4.697 | 0.50 | 1.65160 | 58.5 | 0.852 |
| 16 | 26.274 | (variable) | | | |
| 17 | 17.346 | 1.55 | 1.95906 | 17.5 | 0.626 |
| 18 | −97.671 | 0.89 | | | |
| 19 | ∞ | 0.80 | 1.51000 | 60.0 | |
| 20 | ∞ | 0.50 | | | |
| Image | ∞ | | | | |
| plane | | | | | |

Aspherical surface data
The eighth surface
K = 0.00000e+00 A 4 = −2.41442e−04 A 6 = −2.93273e−06
A 8 = −1.31398e−07
The ninth surface
K = 0.00000e+00 A 4 = 1.46781e−04 A 6 = −4.13146e−06
The thirteenth surface
K = 0.00000e+00 A 4 = −4.04672e−05 A 6 = −2.25562e−06
The fourteenth surface
K = 0.00000e+00 A 4 = −2.01018e−04 A 6 = 1.00971e−05
A 8 = −6.79161e−06

Various data

| | |
|---|---|
| Zoom ratio | 4.89 |

| | Wide | | Telephoto |
|---|---|---|---|
| | angle end | Intermediate | end |
| Focal length | 4.41 | 9.89 | 21.55 |
| F-number | 1.85 | 2.88 | 5.09 |
| Half angle of view | 46.53 | 18.41 | 8.40 |
| Image height | 3.20 | 3.2 | 3.20 |
| Total lens length | 39.92 | 35.15 | 41.55 |
| BF | 1.92 | 1.92 | 1.92 |
| d 6 | 14.76 | 4.98 | 0.70 |
| d 7 | 0.75 | 0.77 | 0.80 |
| d16 | 0.50 | 5.51 | 16.15 |

Zoom lens unit data

| | Leading | Focal |
|---|---|---|
| Unit | surface | length |
| 1 | 1 | −11.09 |
| 3 | 8 | 8.42 |
| 4 | 17 | 15.46 |

Single lens data

| | Leading | Focal |
|---|---|---|
| Lens | surface | length |
| 1 | 1 | −18.15 |
| 2 | 3 | −7.68 |
| 3 | 5 | 10.41 |
| 4 | 8 | 9.97 |
| 5 | 10 | 10.53 |
| 6 | 11 | −6.79 |
| 7 | 13 | 7.86 |
| 8 | 15 | −6.08 |
| 9 | 17 | 15.46 |

### Numerical Embodiment 4

Unit mm
Surface data

| Surface | | | | | |
|---|---|---|---|---|---|
| number | r | d | nd | vd | θct |
| 1 | 22.667 | 0.60 | 1.88300 | 40.8 | 0.734 |
| 2 | 22.127 | 0.12 | | | |
| 3 | 24.339 | 0.60 | 1.89190 | 37.1 | 0.720 |
| 4 | 17.554 | (variable) | | | |
| 5 | 17.408 | 0.60 | 1.75106 | 43.1 | 0.710 |
| 6 | 7.209 | 4.00 | | | |
| 7 | −17.254 | 0.50 | 1.49700 | 81.5 | 0.826 |
| 8 | 11.783 | 0.10 | | | |
| 9 | 11.210 | 1.31 | 1.96300 | 24.1 | 0.661 |
| 10 | 39.197 | (variable) | | | |
| 11(stop) | ∞ | (variable) | | | |
| 12* | 8.568 | 1.39 | 1.55332 | 71.7 | 0.816 |
| 13* | −22.436 | 0.10 | | | |
| 14 | 5.750 | 2.21 | 1.49700 | 81.5 | 0.826 |
| 15 | −29.870 | 2.50 | 1.73800 | 32.3 | 0.715 |
| 16 | 5.021 | 1.84 | | | |
| 17* | 8.599 | 3.00 | 1.55332 | 71.7 | 0.816 |
| 18* | −5.745 | 0.35 | | | |
| 19 | −3.705 | 0.50 | 1.61340 | 44.3 | 0.783 |
| 20 | 229.578 | (variable) | | | |
| 21 | 11.411 | 1.02 | 1.95906 | 17.5 | 0.626 |
| 22 | 80.414 | 0.97 | | | 0.626 |
| 23 | ∞ | 0.80 | 1.51000 | 60.0 | |
| 24 | ∞ | 0.50 | | | |
| Image | ∞ | | | | |
| plane | | | | | |

Aspherical surface data
The twelfth surface
K = 0.00000e+00 A 4 = −8.52142e−05 A 6 = −2.98726e−06
A 8 = −1.35718e−07
The thirteenth surface
K = 0.00000e+00 A 4 = 1.37104e−04 A 6 = −5.89903e−06
The seventeenth surface
K = 0.00000e+00 A 4 = −5.77343e−04 A 6 = −7.87271e−05
The eighteenth surface
K = 0.00000e+00 A 4 = −1.47624e−03 A 6 = −9.72761e−05
A 8 = −1.26067e−05

Various data

| | |
|---|---|
| Zoom ratio | 4.89 |

| | Wide | | Telephoto |
|---|---|---|---|
| | angle end | Intermediate | end |
| Focal length | 4.35 | 9.15 | 21.26 |
| F-number | 1.85 | 2.88 | 5.09 |
| Half angle of view | 41.58 | 19.50 | 8.40 |
| Image height | 3.20 | 3.20 | 3.20 |
| Total lens length | 41.00 | 41.00 | 41.00 |
| BF | 2.00 | 2.00 | 2.00 |
| d 4 | 1.11 | 6.81 | 0.97 |
| d10 | 16.54 | 5.81 | 0.98 |
| d11 | 0.10 | 0.32 | 0.80 |
| d20 | 0.50 | 5.30 | 15.49 |

Zoom lens unit data

| | Leading | Focal |
|---|---|---|
| Unit | surface | length |
| 1 | 1 | −72.1 |
| 2 | 5 | −14.20 |
| 4 | 12 | 8.49 |
| 5 | 21 | 13.77 |

Single lens data

| | Leading | Focal |
|---|---|---|
| Lens | surface | length |
| 1 | 1 | −2199.05 |
| 2 | 3 | −73.66 |
| 3 | 5 | −16.81 |
| 4 | 7 | −14.01 |
| 5 | 9 | 15.94 |
| 6 | 12 | 11.39 |
| 7 | 14 | 9.91 |
| 8 | 15 | −5.65 |
| 9 | 17 | 6.73 |
| 10 | 19 | −5.94 |
| 11 | 21 | 13.77 |

### Numerical Embodiment 5

Unit mm
Surface data

| Surface | | | | | |
|---|---|---|---|---|---|
| number | r | d | nd | vd | θct |
| 1 | 201.037 | 2.64 | 1.75106 | 43.1 | 0.710 |
| 2 | 19.452 | 13.35 | | | |
| 3 | −38.541 | 2.98 | 1.49700 | 81.5 | 0.826 |
| 4 | 106.807 | 0.15 | | | |
| 5 | 56.207 | 5.00 | 1.85478 | 24.8 | 0.674 |
| 6 | 33866.841 | (variable) | | | |
| 7(stop) | ∞ | 1.00 | | | |
| 8* | 32.079 | 6.00 | 1.58313 | 59.4 | 0.827 |
| 9* | −67.427 | 1.43 | | | |
| 10 | 17.359 | 4.99 | 1.49700 | 81.5 | 0.826 |
| 11 | 852.564 | 1.00 | 1.51742 | 52.4 | 0.800 |
| 12 | 14.743 | 2.78 | | | |
| 13 | 63.102 | 1.00 | 1.73800 | 32.3 | 0.715 |
| 14 | 17.160 | 4.74 | 1.49700 | 81.5 | 0.826 |
| 15 | −35.791 | (variable) | | | |
| 16 | −47.590 | 1.00 | 1.51633 | 64.1 | 0.869 |
| 17 | 64.651 | (variable) | | | |
| 18 | 26.098 | 4.90 | 1.80400 | 46.5 | 0.772 |
| 19 | −274.816 | 1.80 | 1.65412 | 39.7 | 0.755 |
| 20 | 19.160 | 1.21 | | | |
| 21 | 24.911 | 5.00 | 1.49700 | 81.5 | 0.826 |
| 22 | −69.372 | (variable) | | | |
| 23 | ∞ | 1.20 | 1.51400 | 70.0 | |
| 24 | ∞ | 1.00 | | | |
| Image | ∞ | | | | |
| plane | | | | | |

Aspherical surface data
The eighth surface
K = 0.00000e+00 A 4 = −6.25545e−06 A 6 = 6.40561e−09
A 8 = −4.09596e−11
The ninth surface
K = 0.00000e+00 A 4 = 4.36302e−06 A 6 = 4.11537e−09
A 8 = −3.34407e−11

Various data

| | |
|---|---|
| Zoom ratio | 3.90 |

| | Wide | | Telephoto |
|---|---|---|---|
| | angle end | Intermediate | end |
| Focal length | 12.30 | 21.47 | 48.01 |
| F-number | 1.75 | 2.65 | 4.00 |
| Half angle of view | 55.56 | 29.16 | 12.79 |
| Image height | 10.75 | 10.75 | 10.75 |
| Total lens length | 123.99 | 123.99 | 123.99 |
| BF | 14.31 | 7.14 | 7.14 |
| d 6 | 41.99 | 25.60 | 1.01 |
| d15 | 3.13 | 10.75 | 36.01 |
| d17 | 3.59 | 19.53 | 18.87 |
| d22 | 12.52 | 5.35 | 5.35 |

Zoom lens unit data

| | Leading | Focal |
|---|---|---|
| Unit | surface | length |
| 1 | 1 | −27.14 |
| 2 | 7 | 29.76 |
| 3 | 16 | −52.93 |
| 4 | 18 | 40.61 |

Single lens data

| | Leading | Focal |
|---|---|---|
| Lens | surface | length |
| 1 | 1 | −28.85 |
| 2 | 3 | −56.60 |
| 3 | 5 | 65.86 |
| 4 | 8 | 38.12 |
| 5 | 10 | 35.58 |
| 6 | 11 | −29.01 |
| 7 | 13 | −32.24 |
| 8 | 14 | 24.05 |
| 9 | 16 | −52.93 |
| 10 | 18 | 29.86 |
| 11 | 19 | −27.32 |
| 12 | 21 | 37.54 |

### Numerical Embodiment 6

Unit mm
Surface data

| Surface | | | | | |
|---|---|---|---|---|---|
| number | r | d | nd | vd | θct |
| 1 | 948.059 | 1.50 | 1.69930 | 51.1 | 0.760 |
| 2 | 22.397 | 4.09 | | | |
| 3 | 45.106 | 1.50 | 1.49700 | 81.5 | 0.826 |
| 4 | 23.025 | 12.00 | | | |
| 5 | −40.318 | 3.00 | 1.49700 | 81.5 | 0.826 |
| 6 | 31.763 | 7.11 | 1.89190 | 37.1 | 0.720 |
| 7 | −40.840 | 0.15 | | | |
| 8 | −38.276 | 1.40 | 1.49700 | 81.5 | 0.826 |
| 9 | 35.582 | (variable) | | | |
| 10(stop) | ∞ | 0.95 | | | |
| 11 | 124.389 | 1.33 | 1.96300 | 24.1 | 0.661 |
| 12 | 6096.891 | 0.10 | | | |
| 13 | 26.572 | 2.05 | 1.75500 | 52.3 | 0.801 |
| 14 | 89.724 | 8.48 | | | |
| 15 | 24.426 | 3.00 | 1.78880 | 28.4 | 0.694 |
| 16 | 15.238 | 0.59 | | | |
| 17 | 20.999 | 3.28 | 1.49700 | 81.5 | 0.826 |
| 18 | −25.731 | 0.30 | | | |
| 19 | −22.473 | 1.00 | 1.61340 | 44.3 | 0.783 |
| 20 | 19.686 | 0.10 | | | |
| 21 | 17.717 | 5.00 | 1.49700 | 81.5 | 0.826 |
| 22 | −33.352 | (variable) | | | |
| 23 | −44.951 | 1.00 | 1.78880 | 28.4 | 0.694 |
| 24 | 28.560 | 2.73 | 1.49700 | 81.5 | 0.826 |
| 25 | −58.326 | 3.96 | | | |
| 26 | 51.986 | 2.06 | 1.49700 | 81.5 | 0.826 |
| 27 | −226.122 | 3.52 | | | |
| 28 | 25.936 | 1.07 | 1.95906 | 17.5 | 0.626 |
| 29 | 28.747 | (variable) | | | |
| 30 | −35.042 | 1.00 | 1.48749 | 70.2 | 0.892 |
| 31 | −53.245 | (variable) | | | |
| 32 | 31.656 | 3.17 | 1.95906 | 17.5 | 0.626 |
| 33 | 101.261 | 11.36 | | | |
| 34 | ∞ | 1.20 | 1.54000 | 70.0 | |
| 35 | ∞ | 1.00 | | | |
| Image | ∞ | | | | |
| plane | | | | | |

Various data

| | |
|---|---|
| Zoom ratio | 1.56 |

| | Wide | | Telephoto |
|---|---|---|---|
| | angle end | Intermediate | end |
| Focal length | 12.00 | 15.29 | 18.73 |
| F-number | 2.61 | 2.97 | 3.25 |
| Half angle of view | 58.13 | 42.90 | 34.24 |
| Image height | 10.75 | 10.75 | 10.75 |
| Total lens length | 128.66 | 128.66 | 128.66 |
| BF | 13.14 | 13.14 | 13.14 |
| d 9 | 28.15 | 20.54 | 13.92 |
| d22 | 0.10 | 3.16 | 5.47 |
| d29 | 10.00 | 4.02 | 11.06 |
| d31 | 1.41 | 11.94 | 9.21 |

Zoom lens unit data

| | Leading | Focal |
|---|---|---|
| Unit | surface | length |
| 1 | 1 | −19.54 |
| 2 | 10 | 29.73 |
| 3 | 23 | −1799.62 |
| 4 | 30 | −214.11 |
| 5 | 32 | 46.97 |

Single lens data

| | Leading | Focal |
|---|---|---|
| Lens | surface | length |
| 1 | 1 | −32.82 |
| 2 | 3 | −96.82 |
| 3 | 5 | −35.26 |
| 4 | 6 | 21.00 |
| 5 | 8 | −36.87 |
| 6 | 11 | 131.84 |
| 7 | 13 | 49.31 |
| 8 | 15 | −60.00 |
| 9 | 17 | 23.82 |
| 10 | 19 | −16.95 |
| 11 | 21 | 24.06 |
| 12 | 23 | −22.01 |
| 13 | 24 | 38.98 |
| 14 | 26 | 85.26 |
| 15 | 28 | 233.14 |
| 16 | 30 | −214.11 |
| 17 | 32 | 46.97 |

### Numerical Embodiment 7

Unit mm
Surface data

| Surface | | | | | |
|---|---|---|---|---|---|
| number | r | d | nd | vd | θct |
| 1 | 151.965 | 1.50 | 1.75106 | 43.1 | 0.710 |
| 2 | 23.277 | 9.39 | | | |
| 3 | −47.393 | 3.00 | 1.49700 | 81.5 | 0.826 |
| 4 | 28.852 | 5.72 | | | |
| 5 | −110.789 | 3.50 | 1.49700 | 81.5 | 0.826 |
| 6 | 56.583 | 10.00 | 1.95375 | 32.3 | 0.699 |
| 7 | −49.847 | 0.14 | | | |
| 8 | −46.250 | 3.50 | 1.49700 | 81.5 | 0.826 |
| 9 | 282.758 | (variable) | | | |
| 10(stop) | ∞ | 0.95 | | | |
| 11 | 32.470 | 5.00 | 2.00330 | 28.3 | 0.684 |
| 12 | −1082.761 | 0.69 | | | |
| 13 | 31.495 | 3.05 | 1.69930 | 51.1 | 0.760 |
| 14 | 465.195 | 0.32 | | | |
| 15 | −128.211 | 3.00 | 1.73800 | 32.3 | 0.715 |
| 16 | 18.792 | 0.86 | | | |
| 17 | 24.232 | 2.75 | 1.49700 | 81.5 | 0.826 |
| 18 | −39.876 | 2.23 | | | |
| 19 | −39.734 | 1.35 | 1.73800 | 32.3 | 0.715 |
| 20 | 21.710 | 0.10 | | | |
| 21 | 21.469 | 2.79 | 1.49700 | 81.5 | 0.826 |
| 22 | −36.329 | (variable) | | | |
| 23 | −22.351 | 2.50 | 1.85478 | 24.8 | 0.674 |
| 24 | 36.740 | 3.12 | 1.49700 | 81.5 | 0.826 |
| 25 | −30.262 | 0.49 | | | |
| 26 | −447.249 | 1.83 | 2.00330 | 28.3 | 0.684 |
| 27 | −51.036 | 0.10 | | | |
| 28 | 42.369 | 7.89 | 1.43875 | 94.7 | 0.841 |
| 29 | −28.443 | (variable) | | | |
| 30 | −32.682 | 1.00 | 1.51633 | 64.1 | 0.869 |
| 31 | 216.335 | (variable) | | | |
| 32 | 38.262 | 3.40 | 1.95906 | 17.5 | 0.626 |
| 33 | 1197.540 | 13.13 | | | |
| 34 | ∞ | 1.20 | 1.54000 | 70.0 | |
| 35 | ∞ | 1.00 | | | |
| Image | ∞ | | | | |
| plane | | | | | |

Various data

| | |
|---|---|
| Zoom ratio | 1.50 |

| | Wide | | Telephoto |
|---|---|---|---|
| | angle end | Intermediate | end |
| Focal length | 12.00 | 14.98 | 18.00 |
| F-number | 2.22 | 2.54 | 2.81 |
| Half angle of view | 56.94 | 43.2 | 35.21 |
| Image height | 10.75 | 10.75 | 10.75 |
| Total lens length | 129.19 | 129.19 | 129.19 |
| BF | 14.91 | 14.91 | 14.91 |
| d 9 | 22.75 | 15.13 | 8.52 |
| d22 | 1.55 | 4.61 | 6.92 |
| d29 | 1.83 | 1.06 | 1.85 |
| d31 | 7.99 | 13.31 | 16.82 |

Zoom lens unit data

| | Leading | Focal |
|---|---|---|
| Unit | surface | length |
| 1 | 1 | −23.92 |
| 2 | 10 | 32.38 |
| 3 | 23 | 45.66 |
| 4 | 30 | −54.91 |
| 5 | 32 | 41.15 |

Single lens data

| | Leading | Focal |
|---|---|---|
| Lens | surface | length |
| 1 | 1 | −36.78 |
| 2 | 3 | −35.62 |
| 3 | 5 | −74.84 |
| 4 | 6 | 29.12 |
| 5 | 8 | −79.69 |
| 6 | 11 | 31.49 |
| 7 | 13 | 48.17 |
| 8 | 15 | −22.02 |
| 9 | 17 | 30.77 |
| 10 | 19 | −18.85 |
| 11 | 21 | 27.59 |
| 12 | 23 | −15.95 |
| 13 | 24 | 33.91 |
| 14 | 26 | 57.29 |
| 15 | 28 | 40.15 |
| 16 | 30 | −54.91 |
| 17 | 32 | 41.15 |

TABLE 1

| | | Numerical Embodiment | | | | | | |
|---|---|---|---|---|---|---|---|---|
| Inequality | | 1 | 2 | 3 | 4 | 5 | 6 | 7 |
| (1) | nd_BNn | 1.85920 | 1.85920 | 1.69930 | 1.75106 | 1.75106 | 1.69930 | 1.75106 |
| | Lens | L11 | L11 | L12 | L21 | L11 | L11 | L11 |
| (2) | vd_BNn | 33.0 | 33.0 | 51.1 | 43.1 | 43.1 | 51.1 | 43.1 |
| | Lens | L11 | L11 | L12 | L21 | L11 | L11 | L11 |
| (3) | θct_BNn- | 0.5484 | 0.5484 | 0.5469 | 0.5303 | 0.5303 | 0.5469 | 0.5303 |
| | 0.00417vd_BNn | | | | | | | |
| | Lens | L11 | L11 | L12 | L21 | L11 | L11 | L11 |
| (4) | vd_BNp | 32.3 | 28.4 | 28.3 | 24.1 | 24.8 | 37.1 | 32.3 |
| | Lens | L13 | L13 | L13 | L23 | L13 | L14 | L14 |
| (5) | \|f_BN/D_BN\| | 0.7 | 0.6 | 1.5 | 2.2 | 1.1 | 0.6 | 0.7 |
| | Lens unit | B1 | B1 | B1 | B2 | B1 | B1 | B1 |
| (6) | n_BPn | 1.67300 | 1.85478 | 1.65160 | 1.61340 | 1.73800 | 1.78880 | 1.73800 |
| | Lens | L25 | L23 | L25 | L35 | L24 | L23 | L23 |
| (7) | vd_BPn | 38.3 | 24.8 | 58.5 | 44.3 | 32.3 | 28.4 | 32.3 |
| | Lens | L25 | L23 | L25 | L35 | L24 | L23 | L23 |
| (8) | θct_BPn- | 0.5458 | 0.5431 | 0.5431 | 0.5491 | 0.5445 | 0.544 | 0.5445 |
| | 0.00528vd_BPn | | | | | | | |
| | Lens | L25 | L23 | L25 | L35 | L24 | L23 | L23 |
| (9) | vd_BPp | 94.7 | 94.7 | 81.5 | 81.5 | 81.5 | 81.5 | 81.5 |
| | Lens | L22 | L22 | L22 | L32 | L22 | L24 | L24 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-156558, filed Sep. 21, 2023, which is hereby incorporated by reference herein in its entirety.

What is claimed is:

1. A zoom lens comprising in order from an object side to an image side, one or more negative lens units each having a negative refractive power, and a positive lens unit having a positive refractive power,
wherein the one or more negative lens units include a BN lens unit including at least one BN negative lens,
wherein the following inequalities are satisfied,
$$1.6 < nd\_BNn < 2 \text{.00}$$
$$25. < ν d\_BNn < 55.$$
$$0.4958 < θ Ct\_BNn - 0.00 \; 417 \times ν d\_BNn < 0.5508$$
where nd_BNn represents a refractive index of the BN negative lens, vd_BNn represents an Abbe number of the BN negative lens, and θCt_BNn represents a partial dispersion ratio of the BN negative lens.

2. The zoom lens according to claim 1, wherein the zoom lens includes five or less lens units.

3. The zoom lens according to claim 1, wherein the one or more negative lens units comprise one or two negative units each having a negative refractive power.

4. The zoom lens according to claim 1, wherein the BN lens unit is a lens unit having a largest negative refractive power among the one or more negative lens units.

5. The zoom lens according to claim 1, wherein the BN lens unit includes two or more and four or less negative lenses.

6. The zoom lens according to claim 1, wherein the BN lens unit includes at least one positive lens that satisfies the following inequality,
$$20. < ν d\_BNp < 40.0$$
where vd_BNp represents an Abbe number of the at least one positive lens.

7. The zoom lens according to claim 1, wherein the following inequality is satisfied,
$$0.5 < \vert f\_BN / D\_BN \vert < 3.$$
where D_BN represents a distance from a lens surface at a most object side to a lens surface at a most image side in the BN lens unit, and f_BN represents a focal length of the BN lens unit.

8. The zoom lens according to claim 1, comprising one or more positive lens units each having a positive refractive power and including three or more lenses,
wherein the one or more positive lens units include a BP lens unit which is arranged at a most object side among the three or more positive lens units and includes at least one BP negative lens which satisfies the following inequalities,
$$1.4 < nd\_BPn < 2 \text{.00}$$
$$15. < ν d\_BPn < 61.$$
$$0.5408 < θ Ct\_BPn - 0.0 \; 0528 \times νd\_BPn < 0.5808$$
where nd_BPn represents a refractive index of the BP negative lens, vd_BPn represents an Abbe number of the BP negative lens, and θCt_BPn represents a partial dispersion ratio of the BP negative lens.

9. The zoom lens according to claim 8, wherein the BP lens unit includes two or less negative lenses.

10. The zoom lens according to claim 8, wherein the BP lens unit includes at least one positive lens satisfying the following inequality,
$$70.5 < νd\_BPp < 100.0$$
where vd_BPp represents an Abbe number of the BP lens unit.

11. The zoom lens according to claim 8, wherein the BP lens unit moves toward the object side during zooming from a wide-angle end to a telephoto end.

12. An image pickup apparatus comprising:
a zoom lens, including in order from an object side to an image side, one or more negative lens units each having a negative refractive power, and a positive lens unit having a positive refractive power,
wherein the one or more negative lens units include a BN lens unit including at least one BN negative lens,
wherein the following inequalities are satisfied,
$$1.6 < nd\_BNn < 2 \text{.00}$$
$$25. < νd\_BNn < 55.$$
$$0.4958 < θ Ct\_BNn - 0.0 \; 0417 \times νd\_BNn < 0.5508$$
where nd_BNn represents a refractive index of the BN negative lens, vd_BNn represents an Abbe number of the BN negative lens, and eCt_BNn represents a partial dispersion ratio of the BN negative lens; and
an image pickup element that receives an image formed by the zoom lens.
